(19) United States
(12) Patent Application Publication
(10) Pub. No.: US 2008/0100595 A1
(43) Pub. Date: May 1, 2008

(54) METHOD FOR ELIMINATING POWER-OFF RESIDUAL IMAGE IN A SYSTEM FOR DISPLAYING IMAGES

(75) Inventors: Chung-Her Wu, Kaohsiung City (TW); Chih-Kuang Lin, Yilan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: TPO DISPLAYS CORP., Miao-Li County (TW)

(21) Appl. No.: 11/554,646

(22) Filed: Oct. 31, 2006

(51) Int. Cl. G09G 5/00

(52) U.S. Cl. 345/204

(57) ABSTRACT

A method of eliminating power-off residual image for a system for displaying images is disclosed, including detecting the end of a final frame by checking a data enable pulse signal, wherein the data enable pulse signal comprises pulses each controlling display of one line of a frame, and generating a white display if the end of the final frame is detected.

### BACKGROUND

The invention relates to image display and more particularly to a method for eliminating power-off residual image in a system for displaying images and a system utilizing the same.

FIG. 1 is a schematic block diagram of a conventional system for displaying images, such as a liquid crystal display, an original light emitting display, or a plasma display. As shown in the figure, an interface 10 processes image data received from an image data supply source such as a personal computer (not shown) and applies TTL interface signals (STTLI) including display data (DATA1) and control signals (CONT1) to a timing controller 12. The control signals (CONT1) typically include an input clock signal (CLK), a horizontal synchronizing signal (HSYNC), a vertical synchronizing signal (VSYNC), and a data enable pulse signal (DE).

The timing controller 12 rearranges the display data (DATA1) into data (DATA2) so that predetermined bits of data can be supplied to a data driver (not shown) in a display panel 14 (i.e. a liquid crystal display panel, an original light emitting display panel, or a plasma display panel). The timing controller 12 also uses the received control signals (CONT1) to produce various control signals (CONT2) suitable for driving a gate driver (not shown) and the data driver in the display panel 14. A power supplier 16 provides power to the interface 10, timing controller 12 and display panel 14.

Among the TTL interface signals (STTLI), the display data (DATA1) is display-use data of image data segmented into each line along time axis. The horizontal synchronizing signal (HSYNC) represents the time required to display one line of one frame. The vertical synchronizing signal (VSYNC) represents the time required to display one frame. The input clock signal (CLK) is a clock signal having the same data rate (repetition frequency) as that of the display data (DATA1). The data enable pulse signal (DE) is a synchronization control signal with the display data (DATA1) to represent the time required to supply the pixel with a data.

FIG. 2 is a timing chart showing driving timing in the vertical direction of the conventional system for display images shown in FIG. 1. Part (A) of FIG. 2 shows the vertical synchronizing signal VSYNC, part (B) shows the horizontal synchronizing signal HSYNC, part (C) shows the display data DATA1, and part (D) shows the data enable pulse signal DE. Further, a symbol Tv denotes a vertical cycle period, Tvp denotes a vertical blanking period, Tvd denotes a display valid period, and Tvb and Tvf denote a back porch and a front porch of the display valid period Tvd, respectively.

In the data enable pulse signal (DE), a data period for each line of the display data (DATA1) is indicated as a valid display data period by a high level, and a data intermission is indicated as an invalid period by a low level. Further, a frame intermission between the last line of a frame and the first line of the next frame is indicated by a low level at a longer time. That is, horizontal synchronization is carried out in response to a rise from low to high in the data enable pulse signal (DE), while vertical synchronization is carried out in response to a long low level period in the data enable pulse signal (DE).

FIG. 3 is a timing diagram of the output voltage (Vo) of the power supplier 16, and the TTL interface signals (STTLI) in FIG. 1 illustrating power-off sequence of the signals. To prevent latch-up or DC operation in the system for display images, the time (t₁) at which the TTL interface signals (STTLI) are disabled typically occurs earlier than the time (t₂) at which the voltage (Vo) supplied by the power supplier 16 is interrupted. The difference between t₁ and t₂ is represented by T_{D} in the figure. However, after the TTL interface signals (STTLI) are disabled, charges remain on pixels of display panel 14, generating residual image in period T_{D}, known as power-off mura.

### SUMMARY

Therefore, the invention provides a method for eliminating power-off residual image in a system for displaying images. A system for displaying images with reduced power-off residual image is also disclosed.

The method of eliminating power-off residual image for a system for displaying images, comprising: detecting the end of a final frame by checking a data enable pulse signal, wherein the data enable pulse signal comprises pulses each controlling display of one line of a frame, and generating a white display if the end of the final frame is detected.

The system for displaying images of the invention comprises an interface operative to output first data and first control signals, a display panel having pixels to display images corresponding to the first data, and a timing controller coupled between the interface and the display panel, operative to convert the first data and the first control signals into second data and second control signals to drive the display pane. The first control signals comprise a data enable pulse signal operative to control one line of a frame of the display panel. The timing controller detects the data enable pulse signal to check the end of a final frame of the display panel. If the end of the final frame is detected, the timing controller drives the display panel to generate a white display.

Since the white display releases residual charges from pixels of the display panel, power-off residual image is eliminated.

### BRIEF DESCRIPTION OF THE DRAWINGS

The foregoing and other advantages and features of the invention will become more apparent from the detailed description of exemplary embodiments of the invention given below with reference to the accompanying drawings in which:

FIG. 1 is a schematic block diagram of a conventional system for displaying images;

FIG. 2 is a timing chart showing driving timings in the vertical direction of the conventional system shown in FIG. 1;

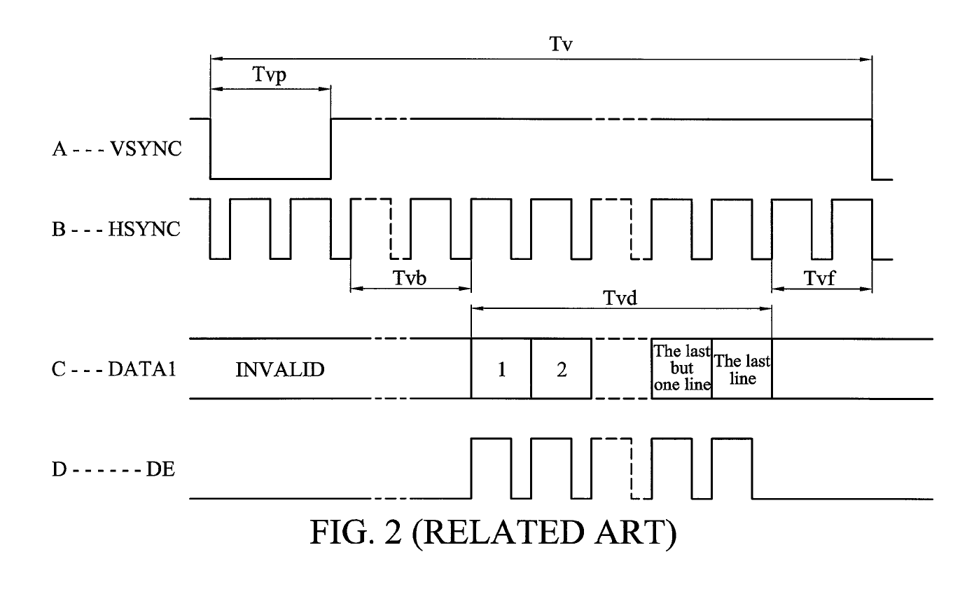

FIG. 3 is a timing diagram of the output voltage Vo of the power supplier, TTL interface signals in FIG. 1 to illustrate power off sequence of the signals;

FIG. 4 is a flowchart schematically showing reduction of power-off residual image in association with the system of FIG. 1 according to the invention;

FIG. 5 shows waveforms of the display data and data enable pulse signal when the system is powered off; and

FIG. 6 is a block diagram of the electronic device 600.

### DETAILED DESCRIPTION

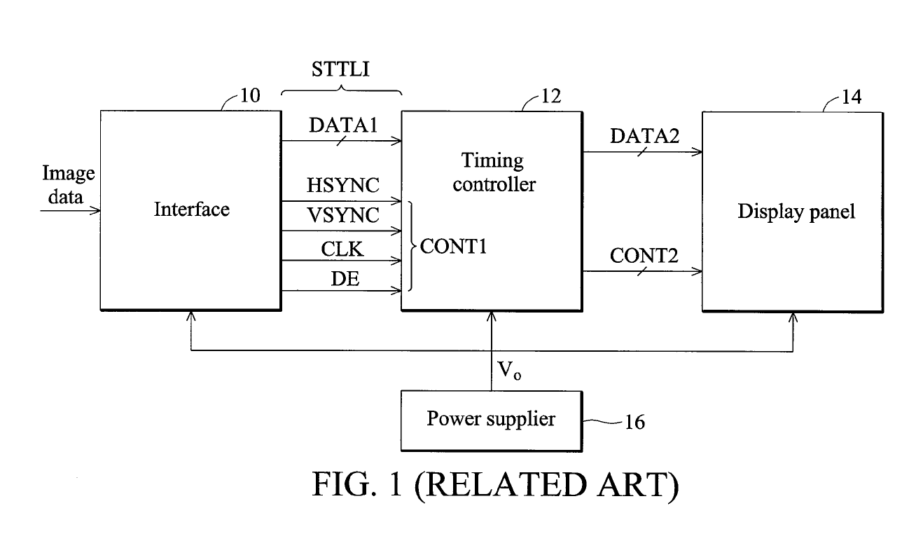

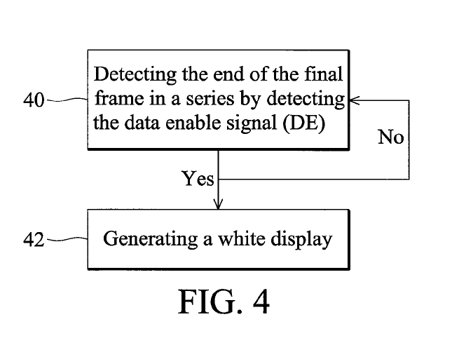

FIG. 4 is a flowchart schematically showing reduction of power-off residual image in association with the system for displaying images of FIG. 1 according to the invention.

In Step 40, detecting the end of the final frame in a series is carried out by checking the data enable pulse signal (DE) input to the timing controller 12 (as shown in FIG. 1). The step is performed when the system is powered on and a series of DE pulses of the data enable pulse signal (DE) is generated and supplied to the timing controller 12.

If the end of the final frame in a series is detected (Yes), then step 42 is performed, that is, a white display is generated on the display panel 42. However, if the end of the final frame in a series is not detected (No), step 40 continues until the end of the final frame in a series is detected. Generation of a white display means that the various control signals (CONT2) input to the display panel 14 are set such that all thin-film transistors (TFTs) connected to pixels on the display panel 14 are turned on, causing the display panel 12 to produce a complete white display. For example, for a one-to-three data driver receiving 6-bit data (DATA2) in the display panel 14, the various control signals (CONT2) comprise 6 clock signals, including CKH11, CHK12 (both controlling red data), CKH21, CKK22 (both controlling blue data), CKH31, CKH32 (both controlling green data), to control transmission of the data (DATA2) to the data driver. When the end of the final frame in a series is detected, the 6 clock signals including CKH11 to CKH32 are all pulled high. Accordingly, TFTs connected to red, blue, and green pixels are turned on. Resultingly, residual charges on the pixels are released and no residual image is generated.

In an embodiment of step 40, whether any data enable pulse signal is generated after a most recent pulse of the data enable signal during a predetermined period is checked. If the data enable pulse signal is not detected in the predetermined period, the most recent pulse is determined to be a pulse controlling the last line of the last frame in a series. The end of the final frame in a series is thus detected and step 42 is executed immediately.

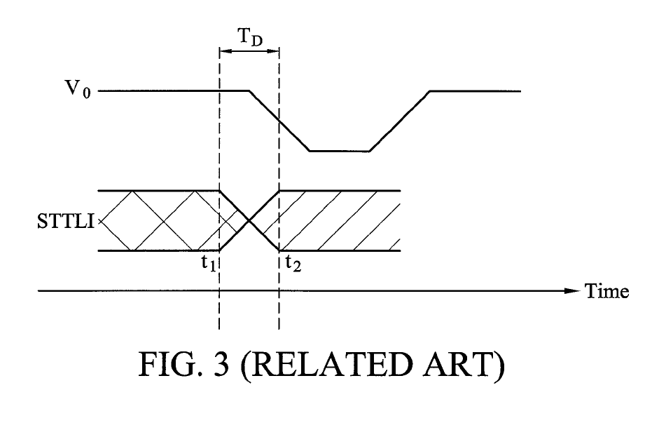

In an embodiment, the predetermined period is determined according to the period from the rising edge of a pulse previous to the most recent pulse to the rising edge of the most recent pulse. For example, the predetermined period is set proportional to the period from the rising edge of a pulse previous to the most recent pulse to the rising edge of the most recent pulse. Note that, in order to effectively prevent power-off residual images, the predetermined period is preferably set to much less than the period T_{D} in FIG. 3.

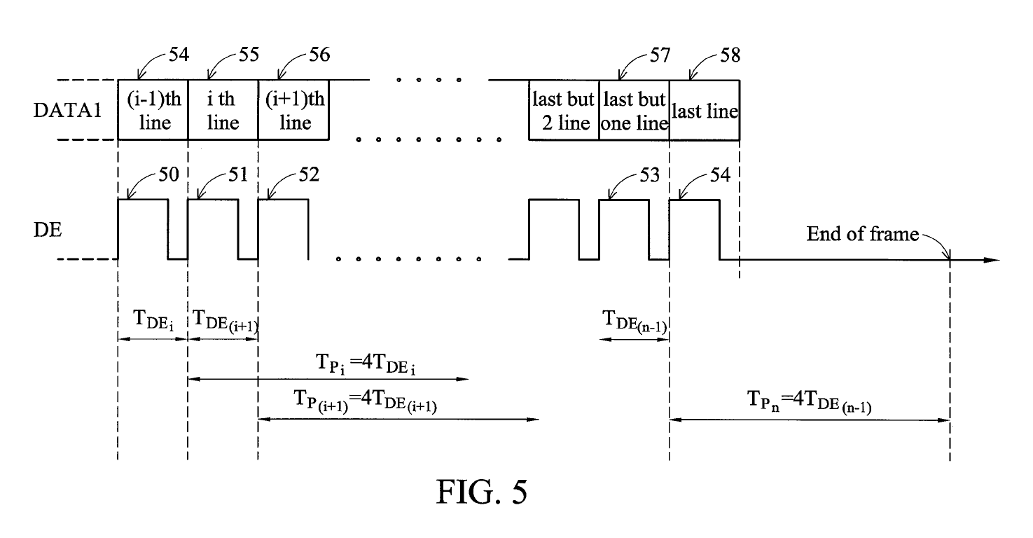

The predetermined period is four times the period from the rising edge of a pulse previous to the most recent pulse to the rising edge of the most recent pulse and begins at the rising edge of the most recent pulse of the data enable signal in accordance with an embodiment of the invention. FIG. 5 shows waveforms of the display data (DATA1) and the data enable pulse signal (DE) when the system is powered off in the embodiment. Referring to FIG. 5, when pulse 51 corresponding the ith line 55 is detected, the most recent pulse is defined as pulse 51, and the predetermined period is changed to T_{Pi} which is four times the period T_{DEi}, wherein the period T_{DEi} is from the rising edge tᵢ₋₁ of a pulse 50 previous to pulse 51 (pulse 50 corresponds to the (i−1)th line) to the rising edge tᵢ of the pulse 51 and the predetermined period T_{Pi} begins at the rising edge of the pulse 51. Whether the data enable pulse signal DE is generated after the most recent pulse 51 during the predetermined period T_{Pi} is then checked as described in step 40. As shown, in the period Tₚᵢ, pulse 52 corresponding to the (i+1)th line is generated after the pulse 51 and can be detected in step 40, indicating the ith line 55 is not the last line of the last frame. As such, the end of the frame is not detected, and step 40 is performed again. Since pulse 52 is detected, the most recent pulse is defined as pulse 52, and the predetermined period is changed to T_{P(i+1)} which is four times the period T_{DE(i+1)}, wherein the period T_{DE(i+1)} is from the rising edge tᵢ of the pulse 51 previous to pulse 52 (to the rising edge tᵢ₊₁ of the pulse 52 and the predetermined period T_{Pi} begins at the rising edge of the pulse 52. Similar process continues and is thus repeated for brevity.

Step 40 is performed repeatedly until a pulse 54 corresponding the last line 58 is detected. When pulse 54 is detected, the most recent pulse is defined as pulse 54, and the predetermined period is changed to T_{Pn} which is four times the period T_{De(n-1)}, wherein the period T_{DE(n-1)} is from the rising edge tₙ₋₁ of a pulse 53 previous to pulse 54 (pulse 53 corresponds to the last but one line 57) to the rising edge tₙ of the pulse 54 and the predetermined period T_{Pn} begins at the rising edge of the pulse 54. Whether the data enable pulse signal DE is generated after the most recent pulse 54 during the predetermined period T_{Pn} is then checked as described in step 40. As shown, however, in the period Tₚₙ, no pulse is further generated and detected in step 40. Resultingly, the end of the final frame in the series is determined at the end of period Tₚₙ (time t_{END}).

The invention also discloses a system for display images, differing from the conventional system in FIG. 1 in that the detecting procedure described in step 40 of FIG. 4 is integrated as a function into the timing controller 12. That is, the timing controller 12 detects the data enable pulse signal DE to detect the end of the final frame in a series as described in step 40 of FIG. 4. The timing controller checks whether there is any DE pulse during a predetermined period after the last detected DE pulse to detect the end of the final frame in a series. In a preferable embodiment, the predetermined period is determined according to the last effective period of the data enable signal, wherein the last effective period is the period from the rising edge of the last but one detected pulse to that of the last detected pulse. Preferably, the predetermined period is four times the last effective period of the data enable pulse signal (DE). If the end of the final frame in a series is detected, the timing controller 12 drives the display panel 14 to generate a white display as described in step 42 of FIG. 4. However, if the end of the final frame in a series is not detected, the timing controller 12 continues detecting until the end of the final frame in a series is detected.

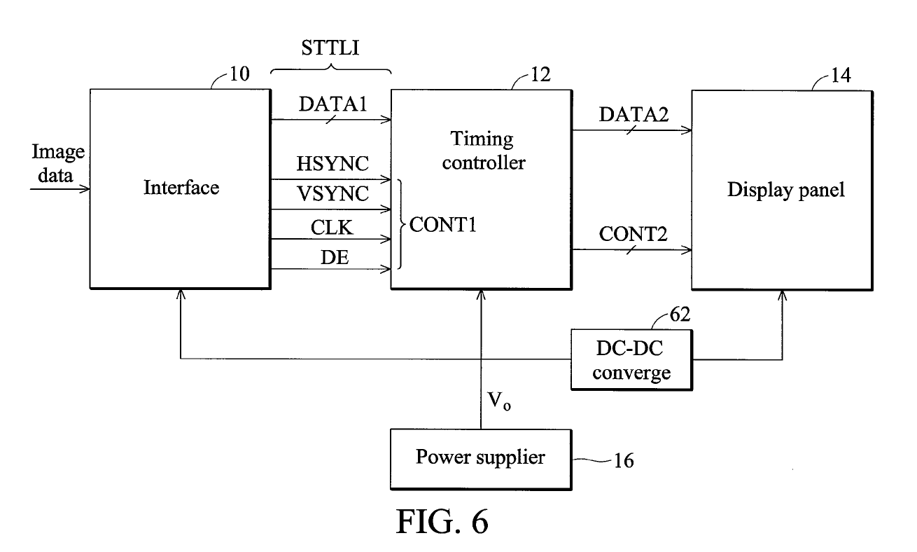

In an embodiment, the system for displaying images further comprises an electronic device. FIG. 6 is a block diagram of the electronic device 600. The electronic device 600 comprises the interface 10, the timing controller 12, the display panel 14, and a DC/DC converter 62 coupled to the display panel 14 and operative to power the display panel 14. The electronic device 600, for example, is a digital camera, a portable DVD, a television, a car display, a PDA, a display monitor, a notebook computer, a tablet computer, or a cellular phone.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of eliminating power-off residual image for a system for displaying images, comprising:
detecting the end of a final frame by checking a data enable pulse signal, wherein the data enable pulse signal comprises pulses each controlling display of one line of a frame; and
generating a white display if the end of the final frame is detected.

2. The method as claimed in claim 1, wherein checking the data enable pulse signal comprises:
checking whether the data enable pulse signal is generated after a most recent pulse of the data enable pulse signal during a predetermined period; and
determining the end of the final frame is detected if so, or otherwise, determining the end of the final frame is not detected.

3. The method as claimed in claim 2, wherein the predetermined period begins at the rising edge of the most recent pulse.

4. The method as claimed in claim 2, wherein the predetermined period is determined according to the period from the rising edge of a pulse previous to the most recent pulse to the rising edge of the most recent pulse.

5. The method of claim 4, wherein the predetermined period is set proportional to the period from the rising edge of the pulse previous to the most recent pulse to the rising edge of the most recent pulse.

6. The method as claimed in claim 5, wherein the predetermined period is four times the period from the rising edge of the pulse previous to the most recent pulse to the rising edge of the most recent pulse.

7. The method as claimed in claim 1, wherein the system is a liquid crystal display, an original light emitting display, or a plasma display.

8. A system for displaying images, comprising:
an interface operative to output first data and first control signals;
a display panel having pixels to display images corresponding to the first data; and
a timing controller coupled between the interface and the display panel, operative to convert the first data and the first control signals into second data and second control signals to drive the display panel,
wherein the first control signals comprise a data enable pulse signal having pulses, each pulse controlling display of one line of a frame;
wherein the timing controller checks the data enable pulse signal to detect the end of a final frame of the display panel; and
if the end of the final frame is detected, the timing controller drives the display panel to generate a white display.

9. The system as claimed in claim 8, wherein in the checking of the data enable pulse signal to detect the end of the final frame of the display panel, the timing controller checks whether the data enable pulse signal is generated after a most recent pulse of the data enable pulse signal during a predetermined period, determines the end of the final frame is detected if so, or otherwise, determines the end of the final frame is not detected.

10. The system as claimed in claim 9, wherein the predetermined period begins at the rising edge of the most recent pulse.

11. The system as claimed in claim 10, wherein the predetermined period is determined according to the period from the rising edge of a pulse previous to the most recent pulse to the rising edge of the most recent pulse.

12. The system as claimed in of claim 11, wherein the predetermined period is set proportional to the period from the rising edge of the pulse previous to the most recent pulse to the rising edge of the most recent pulse.

13. The system as claimed in claim 12, wherein the predetermined period is four times the period from the rising edge of the pulse previous to the most recent pulse to the rising edge of the most recent pulse.

14. The system as claimed in claim 8, wherein the display panel is a liquid crystal display panel, an original light emitting display panel, or a plasma display panel.

15. The system as claimed in claim 8, further comprising an electronic device, wherein the electronic device comprises:
the display panel;
the interface;
the timing controller; and
a DC/DC converter coupled to the display panel and operative to power the display panel.

16. The system as claimed in claim 15, wherein the electronic device is a digital camera, a portable DVD, a television, a car display, a PDA, a display monitor, a notebook computer, a tablet computer, or a cellular phone.
